(19) United States
(12) Patent Application Publication
(10) Pub. No.: US 2010/0232763 A1
(43) Pub. Date: Sep. 16, 2010

(54) RECORDING AND REPRODUCING DEVICE

(75) Inventors: Hiroaki Shimazaki, Osaka (JP); Syouzou Fujii, Osaka (JP); Masafumi Sato, Osaka (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/280,066

(22) PCT Filed: Mar. 12, 2007
(86) PCT No.: PCT/JP2007/054809

§ 371 Date: Aug. 20, 2008

(30) Foreign Application Priority Data
Mar. 17, 2006 (JP) 2006-073887

(51) Int. Cl. G06F 3/048; H04N 5/91

(52) U.S. Cl. 386/95; 715/810; 715/808; 386/E05.003

(57) ABSTRACT

This invention includes: a menu data recording unit (131) that records a menu file onto a recording medium, the menu file for displaying a menu of contents recorded on the recording medium that is portable; a standard form menu file generation unit (129) that generates the menu file in a standard form; a simple form menu file generation unit (130) that generates the menu file in a simple form that takes shorter time than the generation in the standard form; and a menu file selection unit (128) that selects either the standard form menu file generation unit (129) or the simple form menu file generation unit (130) in order to generate the menu file either in the standard form or in the simple form.

### TECHNICAL FIELD

The present invention relates to a recording and reproducing device that records audio and video onto a portable recording medium and reproduces the recorded audio and video.

### BACKGROUND ART

Conventionally, write-once DVD recorders have been proposed that edit recorded content data or record new content data, and then prohibit from reproducing a menu of the content data recorded on a portable recording medium such as a write-once DVD (see Patent Reference 1, for example).

Such a device prohibits such a menu from being reproduced until a new menu is recorded at least. In addition, when a recording medium is ejected from the device, the device generates a menu reflecting details of titles currently recorded on the recording medium, and records the generated menu and management information onto the recording medium.

### [Patent Reference] Japanese Unexamined Patent Application Publication No. 2004-318923

### DISCLOSURE OF INVENTION

### Problems that Invention is to Solve

However, in the conventional technologies, the necessity of the menu generation in ejecting of a recording medium causes a problem of taking a time for processing before the ejecting. This is an impediment for video cameras using DVDs as recording mediums, especially, when recording mediums should be speedily interchanged.

Thus, the present invention overcomes the problem of the conventional technologies as described above. It is an object of the present invention to provide a recording and reproducing device which can generate a necessary menu while reducing processing of generating the menu, when the menu generation is needed in haste, for example when the recording medium is to be ejected from the recording and reproducing device.

### Means to Solve the Problems

In accordance with an aspect of the present invention for achieving the object, there is provided a recording and reproducing device comprising: (a)(a1) a menu data recording unit operable to record menu data onto a recording medium that is portable, the menu data for displaying a menu of content data recorded on the recording medium; (a2) a first form menu data generation unit operable to generate the menu data in a first menu form; (a3) a second form menu data generation unit operable to generate the menu data in a second menu form that takes shorter time than the generation in the first menu form; and (a4) a menu data selection unit operable to select one of said first form menu data generation unit and said second form menu data generation unit in order to generate the menu data either in the first menu form or in the second menu form.

With the structure, the recording and reproducing device according to the present invention can shorten a time required to generate the menu, by generating the menu data in the second menu form when the menu needs to be generated in a short time. As a result, the recording and reproducing device according to the present invention can reduce influence of the menu generation to other operations or processing.

Furthermore, (b) the recording and reproducing device may further includes (b1) a menu data detection unit operable to detect whether or not the menu data is recorded on the recording medium, when the recording medium is set into said recording and reproducing device, (b2) wherein said menu data selection unit is operable to select said second form menu data generation unit to generate the menu data in the second menu form, when said menu data detection unit detects that the menu data is not recorded on the recording medium.

With the structure, when a recording medium such as a DVD is set in the recording and reproducing device, the recording and reproducing device according to the present invention can generate a menu in the second form that takes a shorter time than the generation in the first form, avoiding generating the menu before ejecting the recording medium, for example. Thereby, the recording and reproducing device according to the present invention can reduce the processing before ejecting the recording medium. As a result, video cameras using portable recording mediums such as DVDs can interchange such recording mediums speedily, thereby improving operationality.

Still further, (c) said menu data selection unit may be operable to select said second form menu data generation unit to generate the menu data in the second menu form, when recording of new content data is started or completed

Still further, the recording and reproducing device may further include (d) a warning screen display unit operable to display a warning screen to warn of invalidation of the menu, if the menu data is recorded on the recording medium when said recording and reproducing device is switched to a state of recording the new content data or when said recording and reproducing device starts the recording of the new content data.

With the structure, when recording operation causes invalidation of menu data that has been previously recorded onto the recording medium, the recording and reproducing device according to the present invention displays a warning of the invalidation beforehand. As a result, the recording and reproducing device according to the present invention can prevent undesired invalidation of the menu data.

It should be noted that the present invention can be realized not only as the above-described recording and reproducing device, but also as: a method for controlling the recording and reproducing device (hereinafter, referred to as a “recording and reproducing method”); a program causing a computer to execute the recording and reproducing method (hereinafter, referred to as a “recording and reproducing program”); a recording medium on which the recording and reproducing program is recorded; and the like.

It should also be noted that the present invention can be realized also as: an integrated circuit embedded on the recording and reproducing device (hereinafter, referred to as a “recording and reproducing integration circuit”); design data for forming the recording and reproducing integration circuit in a programmable logic device (hereinafter, referred to as a “recording and reproducing design data”); a recording medium on which the recording and reproducing design data is recorded; and the like.

### Effects of the Invention

According to the present invention, a video camera using portable recording mediums such as DVDs can interchange such recording mediums speedily, by generating a menu in a simple form thereby reducing processing before ejecting the recording medium from the video camera. In addition, a recording and reproducing device according to the present invention is realized that generates menu data in a simple form without background image data when the generation of the menu data should take a shorter time, thereby reducing processing for the menu data generation. Furthermore, when recording operation causes invalidation of menu data that has been previously recorded onto the recording medium, the present invention displays a warning of the invalidation beforehand, thereby preventing undesired invalidation of the menu data.

### BRIEF DESCRIPTION OF DRAWINGS

FIG. 1 is an external view showing a recording and reproducing device according to an embodiment of the present invention.

FIG. 2 is a diagram showing a hardware structure of the recording and reproducing device according to the embodiment of the present invention.

FIG. 3 is a diagram showing a functional structure of a control unit according to the embodiment of the present invention.

FIG. 4 is a diagram showing a display example of a selection screen according to the embodiment of the present invention.

FIG. 5 is a diagram showing a display example of a warning screen according to the embodiment of the present invention.

FIG. 6 is a diagram showing a structure of files recorded on a recording medium according to the embodiment of the present invention.

FIG. 7 is a diagram showing a data structure of a standard form menu file according to the embodiment of the present invention.

FIG. 8 is a diagram showing a screen display example of a standard form menu according to the embodiment of the present invention.

FIG. 9 is a diagram showing a data structure of a simple form menu file according to the embodiment of the present invention.

FIG. 10 is a schematic diagram showing a situation where contents recorded on the recording medium are sequentially reproduced according to a menu file according to the embodiment of the present invention.

FIG. 11 is a flowchart of menu generation processing performed by the control unit according to the embodiment of the present invention.

FIG. 12 is the first flowchart of user operation wait processing performed by the control unit according to the embodiment of the present invention.

FIG. 13 is the second flowchart of the user operation wait processing performed by the control unit according to the embodiment of the present invention.

FIG. 14 is the third flowchart of the user operation wait processing performed by the control unit according to the embodiment of the present invention.

FIG. 15 is the fourth flowchart of the user operation wait processing performed by the control unit according to the embodiment of the present invention.

FIG. 16 is a diagram showing a functional structure of a control unit according to another embodiment of the present invention.

### NUMERICAL REFERENCES

10 recording medium
100 recording and reproducing device
101 lens group
102 imaging unit
103 A/D conversion unit
104 video signal processing unit
105 compression multiplex unit
106 recording processing unit
108 drive control unit
109 receiving unit
110 control unit
111 image generation unit
112 display unit
113 video signal processing unit
114 demultiplex decompression unit
115 reproduction processing unit
121 user operation receiving unit
122 finalizing execution unit
123 menu screen display unit
124 selection screen display unit
125 warning screen display unit
126 content reproduction unit
127 menu file detection unit
128 menu file selection unit
129 standard form menu file generation unit
130 simple form menu file generation unit
131 menu file recording unit
132 mode determination unit
210 control unit
228 menu file selection unit
229 menu file generation unit
230 menu file deletion unit

### BEST MODE FOR CARRYING OUT THE INVENTION

### Embodiment

The following describes a preferred embodiment of the present invention with reference to the drawings.

The recording and reproducing device according to the present embodiment includes the following features (a) to (h).

(a) The recording and reproducing device includes: a menu data recording unit operable to record menu data onto a recording medium that is portable, the menu data for displaying a menu of content data recorded on the recording medium; a first form menu data generation unit operable to generate the menu data in a first menu form; a second form menu data generation unit operable to generate the menu data in a second menu form that takes shorter time than the generation in the first menu form; and a menu data selection unit operable to select one of said first form menu data generation unit and said second form menu data generation unit in order to generate the menu data either in the first menu form or in the second menu form.

(b) The first form menu data generation unit is operable to generate the menu data in the first menu form including a background image; and said second form menu data generation unit is operable to generate the menu data in the second menu form, so that the menu data does not have any background image.

(c) The recording and reproducing device further includes a menu data detection unit operable to detect whether or not the menu data is recorded on the recording medium, when the recording medium is set into said recording and reproducing device, wherein said menu data selection unit is operable to select said second form menu data generation unit to generate the menu data in the second menu form, when said menu data detection unit detects that the menu data is not recorded on the recording medium.

(d) The menu data selection unit is operable to select said second form menu data generation unit to generate the menu data in the second menu form, when content data registered in the menu data is different from the content data recorded on the recording medium in ejecting the recording medium from said recording and reproducing device.

(e) The menu data selection unit is operable to select said second form menu data generation unit to generate the menu data in the second menu form, when recording of new content data is started or completed.

(f) The recording and reproducing device further includes a warning screen display unit operable to display a warning screen to warn of invalidation of the menu, if the menu data is recorded on the recording medium when said recording and reproducing device is switched to a state of recording the new content data or when said recording and reproducing device starts the recording of the new content data.

(g) The recording and reproducing device further includes a user operation receiving unit operable to receive, from a user, an intention whether or not to generate the menu, wherein said menu data selection unit is operable to select said first form menu data generation unit to generate the menu data in the first menu form, when said user operation receiving unit receives an intention to generate the menu.

(h) The recording and reproducing device further includes a selection screen display unit operable to display a selection screen on which the user selects whether or not the menu is to be generated, when finalizing processing is to be performed in the recording medium, wherein said user operation receiving unit is operable to receive, from the user, the intention whether or not to generate the menu, via the selection screen, and said menu data selection unit is operable to select said second form menu data generation unit to generate the menu data in the second menu form, when said user operation receiving unit receives an intention not to generate the menu.

Hereinafter, the content data is referred to simply as a “content”, and the menu data is expressed as a menu file that includes the menu data. The menu data is assumed to be generated by generating the menu file. Based on the above, the following describes the recording and reproducing device according to the present embodiment.

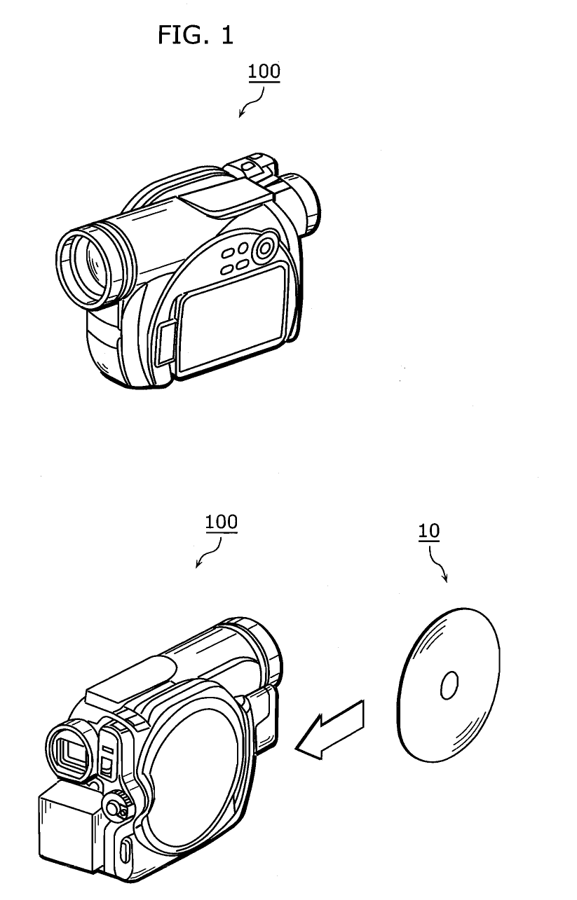

FIG. 1 is an external view of the recording and reproducing device according to the present embodiment. As shown in FIG. 1, a recording and reproducing device 100 has a function of recording audio/video contents onto a recording medium 10. In addition, the recording and reproducing device 100 has another function of reproducing the audio/video contents recorded on the recording medium 10.

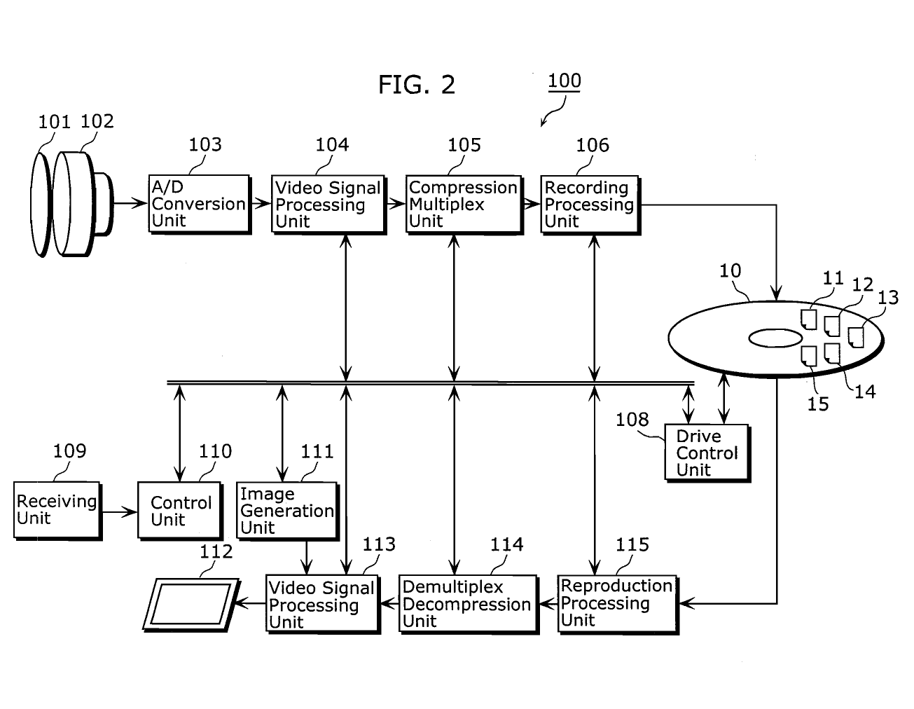

FIG. 2 is a diagram showing a hardware structure of the recording and reproducing device 100 according to the present embodiment. As shown in FIG. 2, the recording and reproducing device 100 includes a lens group 101, an imaging unit 102, an analog-digital (A/D) conversion unit 103, a video signal processing unit 104, a compression multiplex unit 105, a recording processing unit 106, a drive control unit 108, a receiving unit 109, a control unit 110, an image generation unit 111, a display unit 112, a video signal processing unit 113, a demultiplex decompresson unit 114, a reproduction processing unit 115, and the like.

The lens group 101 includes a plurality of optical lenses.

The imaging unit 102 includes an imaging device and the like. The imaging unit 102 captures video that is inputted through the lens group 101. The imaging unit 102 outputs the captured video as analog signals to the A/D conversion unit 103.

The A/D conversion unit 103 converts the analog signals obtained from the imaging unit 102, into digital signals. The A/D conversion unit 103 outputs the resulting converted digital signals to the video signal processing unit 104.

The video signal processing unit 104 converts the digital signals obtained from the A/D conversion unit 103, to video signals. The video signal processing unit 104 outputs the resulting converted video signals to the compression multiplex unit 105.

The compression multiplex unit 105 compresses and multiplexes the video signals obtained from the video signal processing unit 104, using a coding method such as MPEG-2 or H.264. The compression multiplex unit 105 outputs the resulting multiplexed video signals, as a content, to the recording processing unit 106.

The recording processing unit 106 writes the content obtained from the compression multiplex unit 105, onto the recording medium 10.

The drive control unit 108 controls a drive device to drive the recording medium 10.

The receiving unit 109 receives an operation of a user (hereinafter, referred to as a “user operation”) via an input device. The receiving unit 109 outputs the received user operation, as operation information, to the control unit 110.

The control unit 110 controls the video signal processing unit 104, the compression multiplex unit 105, the recording processing unit 106, the drive control unit 108, the image generation unit 111, the video signal processing unit 113, the demultiplex decompresson unit 114, and the reproduction processing unit 115, to perform recording processing, reproduction processing, and the like in the recording and reproducing device 100.

The image generation unit 111 generates a menu image showing a list of contents recorded on the recording medium 10.

The display unit 112 displays the video signals obtained from the video signal processing unit 113, on a monitor or the like.

The video signal processing unit 113 converts an decompressed content obtained from the demultiplex decompresson unit 114, into video signals. The video signal processing unit 113 outputs the resulting converted video signals to the display unit 112. Here, according to need, The video signal processing unit 113 (i) outputs the menu image or the like generated by the image generation unit 111 directly to the display unit 112 as video signals, or (ii) multiplexes with the decompressed content obtained from the demultiplex decompresson unit 114 and then outputted to the display unit 112 as video signals.

The demultiplex decompresson unit 114 demultiplexes and decompresses the content obtained from reproduction processing unit 115, using the coding method such as MPEG-2 or H.264 which has been used by the compression multiplex unit 105. The demultiplex decompresson unit 114 outputs the resulting decompressed content to the video signal processing unit 113.

The reproduction processing unit 115 reads a content from the recording medium 10 to be reproduced. The reproduction processing unit 115 outputs the read content to the demultiplex decompresson unit 114.

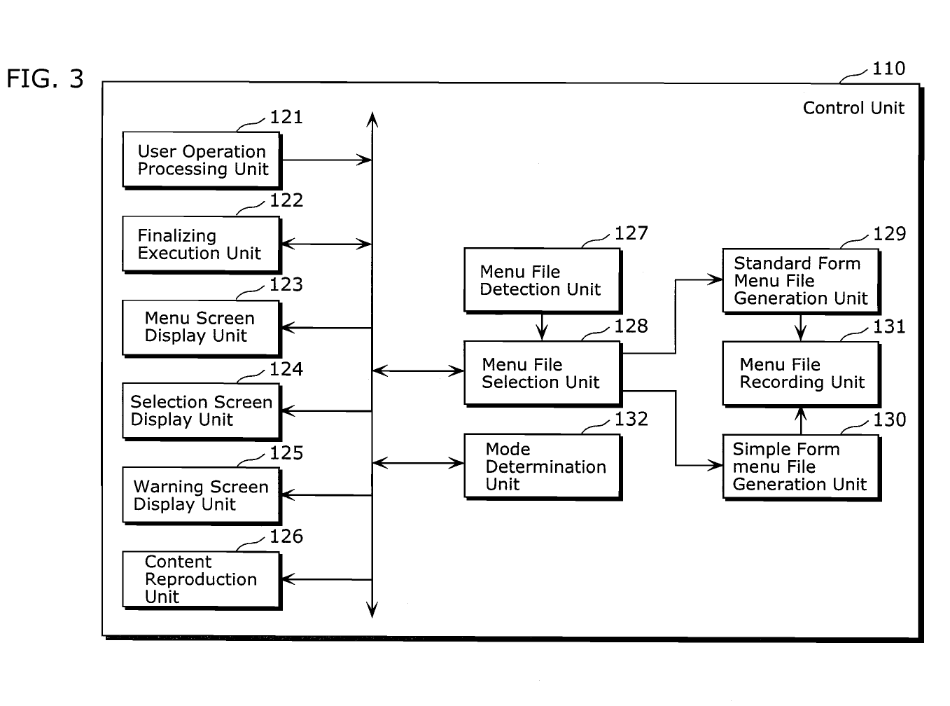

FIG. 3 is a diagram showing a functional structure of the control unit 110 according to the present embodiment. As shown in FIG. 3, the control unit 110 includes a user operation receiving unit 121, a finalizing execution unit 122, a menu screen display unit 123, a selection screen display unit 124, a warning screen display unit 125, a content reproduction unit 126, a menu file detection unit 127, a menu file selection unit 128, a standard form menu file generation unit 129, a simple form menu file generation unit 130, a menu file recording unit 131, a mode determination unit 132, and the like.

The user operation receiving unit 121 receives operation information regarding a user operation, via the receiving unit 109.

For example, when operation information indicating that processing of displaying a menu (hereinafter, referred to as “menu display processing”) is to be performed is received from a user, the user operation receiving unit 121 instructs the menu screen display unit 123 to display a menu. Then, when operation information indicating that processing of reproducing a content (hereinafter, referred to as “content reproduction processing”) is to be performed is received from the user regarding a content selected by the user from the displayed menu, the user operation receiving unit 121 instructs the content reproduction unit 126 to reproduce the content selected by the user.

Here, the menu screen display unit 123 displays a menu which includes a menu file recorded on the recording medium 10, via the display unit 112. The content reproduction unit 126 reads the content to be reproduced from the recording medium 10, and reproduces the content.

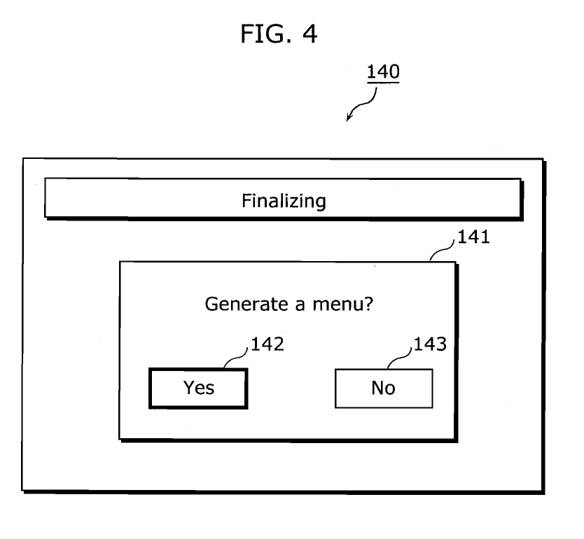

Furthermore, when operation information indicating that finalizing processing is to be performed is received from the user, the user operation receiving unit 121 instructs the selection screen display unit 124 to display a selection screen (see FIG. 4, for example), and also instructs the finalizing execution unit 122 to perform the finalizing processing. Then, when operation information indicating whether or not a menu is to be generated is received from the user via the selection screen, the user operation receiving unit 121 outputs the received operation information to the menu file selection unit 128.

Here, when the finalizing processing is to be performed, the selection screen display unit 124 displays the selection screen (see FIG. 4, for example) via the display unit 112, so that the user can select whether or not a menu is to be generated. The finalizing execution unit 122 performs the finalizing processing.

FIG. 4 is a diagram showing a display example of the selection screen according to the present embodiment. As shown in FIG. 4, when the finalizing processing is to be performed, the selection screen display unit 124 displays a selection screen 140 via the display unit 112, so that the user can select, on the selection screen 140, whether or not a menu is to be generated. Then, the selection screen display unit 124 receives a result of the user's selection, via the receiving unit 109. Here, if a button 142 (Yes) is selected, then the recording and reproducing device 100 generates a menu in a standard form. On the other hand, if a button 143 (No) is selected, then the recording and reproducing device 100 generates a menu in a simple form, not in a standard form.

Subsequently, as shown in FIG. 3, when a menu file is to be generated, the menu file selection unit 128 selects either the standard form menu file generation unit 129 or the simple form menu file generation unit 130, based on the operation information obtained from the user operation receiving unit 121 and detection information obtained from the menu file detection unit 127. Then, the menu file selection unit 128 instructs the selected unit to generate a menu file.

Here, when the recording medium 10 is set into the recording and reproducing device 100, the menu file detection unit 127 detects whether or not any menu file is recorded on the recording medium 10. The menu file detection unit 127 outputs a result of the detection as detection information to the menu file selection unit 128.

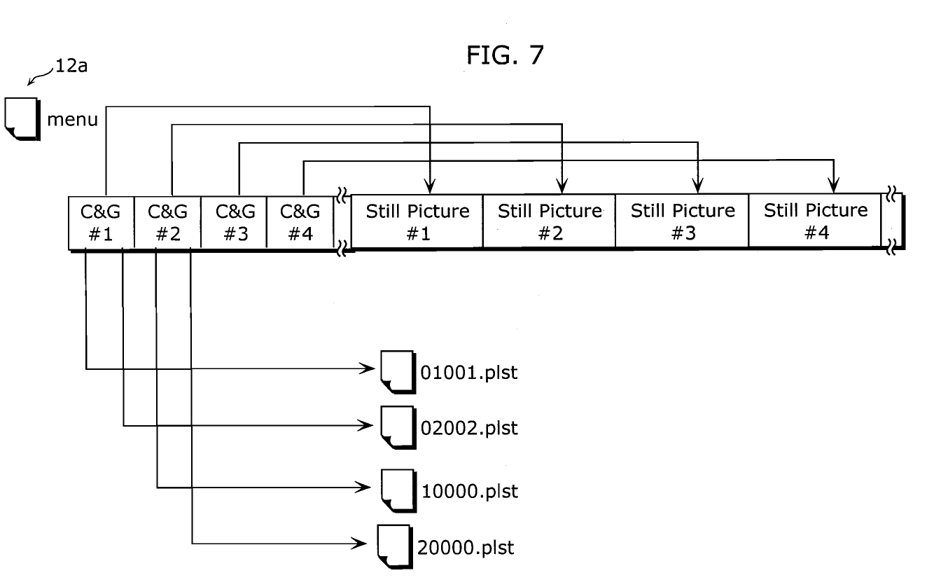

When the standard form menu file generation unit 129 is instructed by the menu file selection unit 128 to generate a menu file, the standard form menu file generation unit 129 generates a menu file in a standard form (see FIG. 7, for example). The standard form menu file generation unit 129 outputs the menu file generated in a standard form (hereinafter, referred to as a “standard form menu file”) to the menu file recording unit 131.

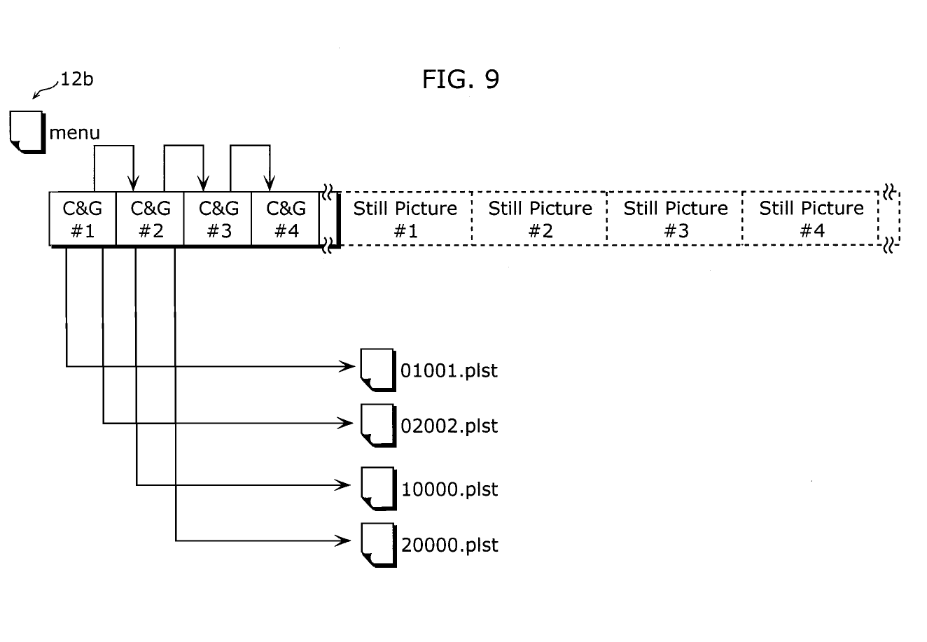

When the simple form menu file generation unit 130 is instructed by the menu file selection unit 128 to generate a menu file, the simple form menu file generation unit 130 generates a menu file in a simple form (see FIG. 9, for example). The menu file in the simple form is generated in a shorter time than the generation in the standard form. The simple form menu file generation unit 130 outputs the menu file generated in the simple form (hereinafter, referred to as a “simple form menu file”) to the menu file recording unit 131.

If the standard form menu file is obtained form the standard form menu file generation unit 129, the menu file recording unit 131 records the obtained standard form menu file onto the recording medium 10 as a menu file. On the other hand, if the simple form menu file is obtained form the simple form menu file generation unit 130, the menu file recording unit 131 records the obtained simple form menu file onto the recording medium 10 as a menu file.

For example, the menu file selection unit 128 selects the standard form menu file generation unit 129, when a standard form menu file is to be generated in situations such as the following (Situation 1) to (Situation 3). On the other hand, the menu file selection unit 128 selects the simple form menu file generation unit 130, when a standard form menu file is not necessary but a menu file is preferably to be generated in a short time in situations such as the following (Situation 4) to (Situation 6).

(Situation 1) If operation information indicating that a standard form menu is to be generated is received from the user operation receiving unit 121, the menu file selection unit 128 selects the standard form menu file generation unit 129. Here, the user operation receiving unit 121 receives the operation information indicating that a standard form menu is to be generated is received from a user, and outputs the received operation information to the menu file selection unit 128.

(Situation 2) When operation information indicating that a menu is to be generated is received from the user operation receiving unit 121, the menu file selection unit 128 selects the standard form menu file generation unit 129. Here, the user operation receiving unit 121 receives the operation information indicating that a menu is to be generated is received from the user, and outputs the received operation information to the menu file selection unit 128.

(Situation 3) When finalizing processing is to be performed and operation information indicating that a menu is to be generated is received from the user operation receiving unit 121, the menu file selection unit 128 selects the standard form menu file generation unit 129. Here, the user operation receiving unit 121 receives the operation information indicating that a menu is to be generated is received from the user via a selection screen displayed for the finalizing processing, and outputs the received operation information to the menu file selection unit 128.

(Situation 4) When finalizing processing is to be performed and operation information indicating that a menu is not to be generated is received from the user operation receiving unit 121, the menu file selection unit 128 selects the simple form menu file generation unit 130. Here, the user operation receiving unit 121 receives the operation information indicating that a menu is not to be generated is received from the user via a selection screen displayed for the finalizing processing, and outputs the received operation information to the menu file selection unit 128.

(Situation 5) When detection information indicating that any menu file is not recorded on the recording medium 10 is received from the menu file detection unit 127, the menu file selection unit 128 selects the simple form menu file generation unit 130. Here, the menu file detection unit 127 detects that any menu file is not recorded on the recording medium 10, and outputs a result of the detection as the detection information to the menu file selection unit 128.

(Situation 6) When the recording medium 10 is to be ejected from the recording and reproducing device 100 after recording processing, deleting processing, or the like is completed, and a determination is made, based on the operation information received from the user operation receiving unit 121 and the detection information received from the menu file detection unit 127, that there is discrepancy between (i) contents registered in the menu file recorded on the recording medium 10 and (ii) contents recorded on the recording medium 10, the menu file selection unit 128 selects the simple form menu file generation unit 130. Here, the menu file detection unit 127 has previously detected that a menu file is recorded on the recording medium 10, and outputs a result of the detection as the detection information to the menu file selection unit 128. In addition, the user operation receiving unit 121 has previously received from the user the operation information indicating that recording processing, deleting processing, or the like is to be performed, and has outputted the received operation information to the menu file selection unit 128. After that, the user operation receiving unit 121 receives from the user the operation information indicating that the recording medium 10 is to be ejected, and outputs the received operation information to the menu file selection unit 128.

It should be noted that, in the above (Situation 6), it is also possible that the menu file selection unit 128 selects the simple form menu file generation unit 130, when the recording processing, the deleting processing, or the like is to be performed, not when the recording medium 10 is to be ejected. In this case, when the menu file selection unit 128 receives from the user operation receiving unit 121 the operation information indicating that the recording processing, the deleting processing, or the like is to be performed, instead of the operation information indicating that the recording medium 10 is to be ejected, the menu file selection unit 128 selects the simple form menu file generation unit 130. Thereby, a menu file is generated every time the recording processing, the deleting processing, or the like is performed. As a result, a menu file is not generated when the recording medium is ejected, thereby reducing processing in the ejecting.

Moreover, when the detection information is received from the menu file detection unit 127, the menu file selection unit 128 outputs the received detection information to the user operation receiving unit 121 and the mode determination unit 132.

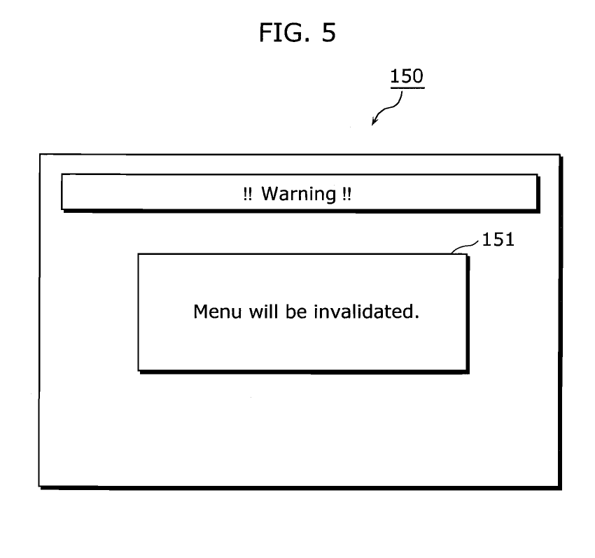

Here, if a menu file is generated and recorded onto the recording medium 10, then the user operation receiving unit 121 attempts to add or delete any content in the recording processing, the deleting processing, or the like, and therefore this will cause discrepancy between (i) contents registered in the menu file and (ii) contents recorded on the recording medium, the user operation receiving unit 121 instructs the warning screen display unit 125 to display a warning screen (refer to FIG. 5, for example). The warning screen display unit 125 displays the warning screen (refer to FIG. 5, for example) warning the user of invalidation of the menu, via the display unit 112.

FIG. 5 is a diagram showing a display example of the warning screen according to the present embodiment. As shown in FIG. 5, when a new content is to be added onto the recording medium 10 after generating a menu, a warning screen 150 is displayed via the display unit 112 to indicate that the menu will be invalidated due to the addition.

In addition, as shown in FIG. 3, when a current operation mode is switched to a mode of capturing image (hereinafter, referred to as an “image capturing mode”) while a menu file is recorded on the recording medium 10, the mode determination unit 132 instructs the warning screen display unit 125 to display such a warning screen (refer to FIG. 5, for example).

In more detail, when the user operation receiving unit 121 receives operation information indicating an operation mode to be set for the recording and reproducing device 100, the mode determination unit 132 determines a current operation mode of the recording and reproducing device 100 using operation information (operation mode) which the user operation receiving unit 121 has previously received. In addition, the mode determination unit 132 stores the operation information (operation mode) which the user operation receiving unit 121 receives. Then, if switch between the operation modes causes any discrepancy between contents recorded on the menu file and contents recorded on the recording medium 10, the mode determination unit 132 instructs the warning screen display unit 125 to display the warning screen (refer to FIG. 5, for example).

Here, it is assumed that the recording and reproducing device 100 has two kinds of operation modes: an image capturing mode and a reproduction mode. Under the assumption, when the reproduction mode is to be switched to the image capturing mode, the mode determination unit 132 determines that a current operation mode of the recording and reproducing device 100 is the reproduction mode, based on the operation information (reproduction mode) that has been stored when the user operation receiving unit 121 has previously received the operation information. In addition, the mode determination unit 132 stores operation information (image capturing mode) which the user operation receiving unit 121 currently receives. Here, the switch from the reproduction mode to the image capturing mode will cause discrepancy between (i) contents recorded on the menu file and (ii) contents recorded on the recording medium 10 including a new content. Therefore, the mode determination unit 132 instructs the warning screen display unit 125 to display the warning screen (refer to FIG. 5, for example).

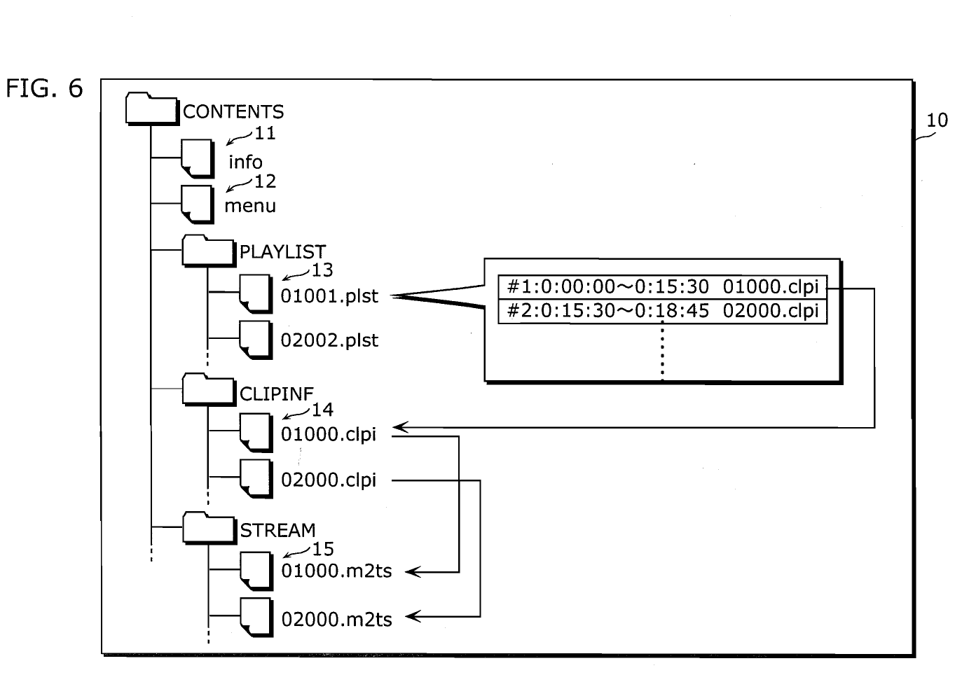

Next, description is given for the standard form menu file and the simple form menu file. Here, thee files are assumed to be recorded on the recording medium 10 in a file structure shown in FIG. 6.

FIG. 6 is a diagram showing a structure of files recorded on the recording medium 10 according to the present embodiment. As shown in FIG. 6, it is assumed that a content folder (CONTENTS) has an information file 11 (info), a menu file 12 (menu), a play list folder (PLAYLIST), a clip information folder (CLIPINFO), a stream folder (STREAM), and the like. The information file (info) 11 includes management information for managing the entire directory. The menu file 12 (menu) has information included in a menu.

In the play list folder (PLAYLIST), a play list file 13 (01001.plst) and the like are stored. The play list file 13 (01001.plst) includes information regarding an order of reproducing contents, for example.

In the clip information folder (CLIPINF), a clip information file 14 (01000.clpi) and the like are stored. The clip information file 14 (01000.clpi) includes a positional relationship between time information and video data, a time table regarding partial reproduction and special reproduction, and the like.

In the stream folder (STREAM), a stream file 15 (01000.m2ts) and the like are stored. The stream file 15 (01000.m2ts) includes audio/video (AV) stream data.

Then, the control unit 110 controls reproduction processing using three kinds of files that are the play list file 13, the clip information file 14, and the stream file 15.

Here, the play list file indicates a clip information file to be reproduced and a reproducing time. When a play list file is reproduced, a clip information file designated by the play list file is referred to and thereby a stream file designated using information such as a time table in the clip information file is reproduced. For example, the play list file 13 (01001.plst) indicates that reproduction is to be performed in an order of a clip (#1) and a clip (#2), for example. In this case, in order to process the clip (#1), a stream file (01000.m2ts) associated with the clip information file (01000.clpi) is reproduced. In order to process the clip (#2), a stream file (02000.m2ts) associated with the clip information file (02000.clpi) is reproduced.

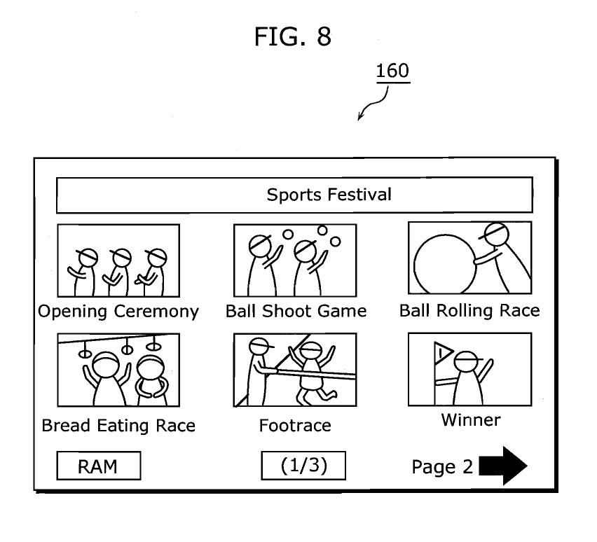

FIG. 7 is a diagram showing a data structure of a standard form menu file according to the present embodiment. As shown in FIG. 7, the menu file 12a is a standard form menu file in which a standard form menu is described. In the standard form menu, contents recorded on the recording medium 10 are listed at one or more pages (refer to FIG. 8, for example).

Here, as one example, the menu file 12a includes “C&G”s in an order of “C&G#1”, “C&G#2”, “C&G#3”, “C&G#4”, . . . . Each of the “C&G”s is in association with a corresponding play list file. Following the “C&G”s, the menu file 12a has “Still Picture”s in an order of “Still Picture #1”, “Still Picture #2”, “Still Picture #3”, “Still Picture #4”, . . . . Each of the “Still Picture”s is in association with a corresponding “C&G”. Here, the “C&G” is data including control information and image information. The “Still Picture” is data generated by coding a background image of a menu. Here, the background image includes images such as frames and buttons which are in association with commands for controlling display of the menu.

For example, according to the “C&G#1”, the recording and reproducing device 100 displays the first page of a menu. As a background image, the first page includes thumbnail images of clips described in a play list file (01001.plst) and a play list file (02002.plst). Then, when the first page of the menu is displayed and then a user operates to display a next page, the same processing as described above is performed according to the “C&G#2” following the “C&G#1”. Then, the second page of the menu is displayed. As a background image, the second page includes thumbnail images of clips described in a play list file (10000.plst) and a play list file (20000.plst). Subsequently, the same processing is performed according to the “C&G#3” and the “C&G#4”.

FIG. 8 is a diagram showing a screen display example of a standard form menu according to the present embodiment. As shown in FIG. 8, when reproduction is performed according to the menu file 12a, the control unit 110 firstly displays a menu screen 160 using a “Still Picture#1” as a background image according to the

“C&G#1”. In more detail, a background mage in which six thumbnail images such as “opening ceremony” and “ball shoot game” are arranged is coded as the “Still Picture#1”. Image information regarding color or a shape changeable by user operations (for example, an arrow indicating “Page 2”, a frame showing a selected thumbnail image, and the like) is stored in the “C&G#1” together with the control information. Then, when the user selects a thumbnail image to be reproduced from the menu and performs a reproduction operation, the control unit 110 reproduces a stream file with reference to a play list file in association with the selected thumbnail image.

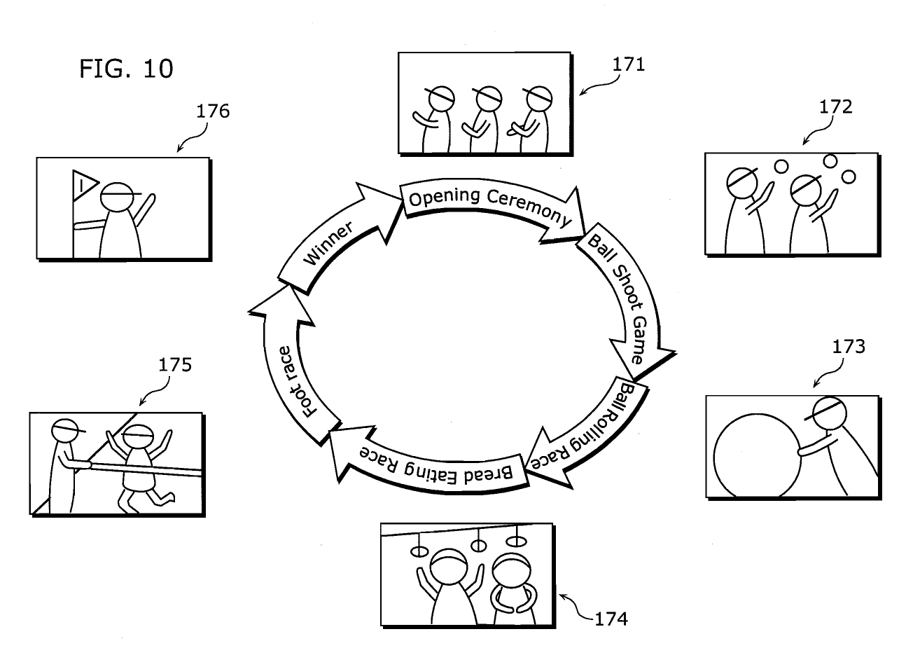

FIG. 9 is a diagram showing a data structure of a simple form menu file according to the present embodiment. As shown in FIG. 7, the menu file 12b is a simple form menu file in which a simple form menu is described. In the simple form menu, contents recorded on the recording medium 10 are automatically reproduced one by one (refer to FIG. 10, for example).

Here, as one example, the menu file 12b has only “C&G”s in an order of “C&G#1”, “C&G#2”, “C&G#3”, “C&G#4”, . . . . Here, the menu file 12b does not include any “Still Picture”s in association with the respective “C&G”s as in the standard form menu file. Since the menu file does not have any “Still Picture”, the “C&G” is data having only control information without any image information.

For example, according to the “C&G#1”, the recording and reproducing device 100 displays clips described in the play list file (01001.plst) and the play list file (02002.plst) sequentially. After the display, the same processing as described above is performed according to the “C&G#2” following the “C&G#1”. Then, clips described in the play list file (10000.plst) and the play list file (20000.plst) are displayed sequentially. Subsequently, the same processing is performed according to the ““C&G#3” and the “C&G#4”.

FIG. 10 is a schematic diagram showing a situation where contents recorded on the recording medium 10 are sequentially reproduced according to the menu file according to the present embodiment. As shown in FIG. 10, it is assumed that a content 171 (opening ceremony), a content 172 (ball shoot game), a content 173 (ball rolling race), a content 174 (bread eating race), a content 175 (footrace), and a content 176 (winner) are recorded on the recording medium 10. It is also assumed that, at default, the menu file includes “C&G#1” to “C&G#6” in association with the respective contents 171 to 176. It is further assumed that each of the

“C&G#1” to “C&G#6” has only control information. According to the menu file, the control unit 110 reproduces the contents 171 to 176 sequentially.

As described above, by generating the simple form menu instead of the standard form menu, it is possible to shorten a time required to generate a menu file. Especially, when the simple form menu is generated, “Still Picture#1” and the like which form a background image in the standard form menu do not need to be generated, coded, nor recorded. Therefore, a time required to generate a menu file can be shortened.

Here, the following description is given under the assumption that a background image on a last page of a standard form menu has only three thumbnail images. Under the assumption, when a content is added, the background image needs to be re-generated to have four thumbnail images, in order to correspond to the contents recorded on the recording medium 10. In this case, the re-generation of the background image requires re-coding of the “Still Picture” shown in FIG. 7. Therefore, generation of the standard form menu file takes a longer time than generation of the simple form menu file, which increases influence on other processing or operations.

Moreover, if a standard form menu file is generated when the recording medium 10 is to be ejected from the recording and reproducing device 100, the ejection is delayed until completion of the generation, which increases a time required for the ejection. Therefore, the generation of a standard form menu file due to addition or deletion of a content damages operationality significantly.

For the above cases, the recording and reproducing device 100 generates a simple form menu file instead, when a menu file is to be generated in a short time. Thereby, it is possible to prevent re-generation of a background image. As a result, the generation of a simple form menu file can reduce the influence on other processing or operations more than the generation of a standard form menu file. Eventually, operationality can be improved.

Moreover, the re-generation of a menu file is not always required, for example when a content is recorded but then deleted. In such a case, if a standard form menu file is generated every time a content is recorded or deleted, the generation affects other processing and operations significantly. Furthermore, in this case, there is no need to generate a simple form menu file to be replaced with the standard form menu file.

Therefore, when a menu file is to be re-generated, the recording and reproducing device 100 displays a warning screen (refer to FIG. 5, for example) to reduce influence on other processing or operations and also provide the user with more flexible way leaving judgment to the user.

It should be noted that it has been described that a simple form menu file is generated due to addition or deletion of a content, but it is also possible to delete or invalidate a menu fie. This also improves operationality. However, when reproduction is performed by a reproducing device different from the recording and reproducing device 100, the reproducing device does not always perform the same reproduction processing as the recording and reproducing device 100 if there is no compatibility between the reproduction device and the recording and reproducing device 100.

For example, if processing performed when any menu file is not recorded on a recording medium is different between the recording and reproducing device 100 and a different reproducing device, reproduction processing performed by these devices would not be the same. However, if a simple form menu file is generated and recorded on the recording medium, even if other reproduction devices different from the recording and reproducing device 100 perform reproduction, the other reproduction devices perform the reproduction processing as processing for the case where a menu file is recorded, so that the same reproduction processing as the reproduction processing of the recording and reproducing device 100 is performed. However, when the menu file is invalidated, the reproduction processing is not always performed properly.

Next, processing performed by the recording and reproducing device 100 having the above structure is described.

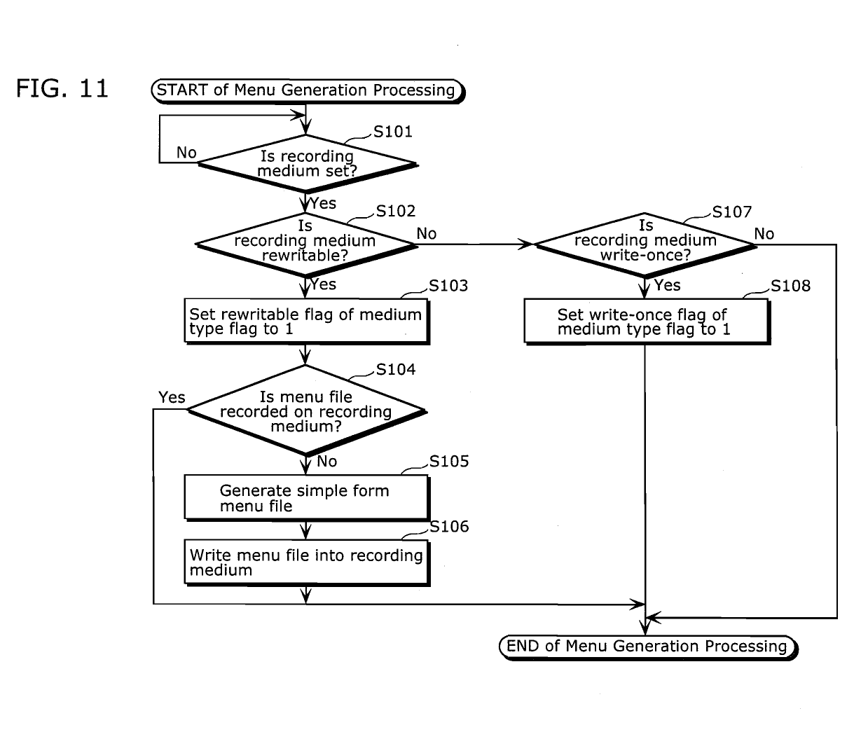

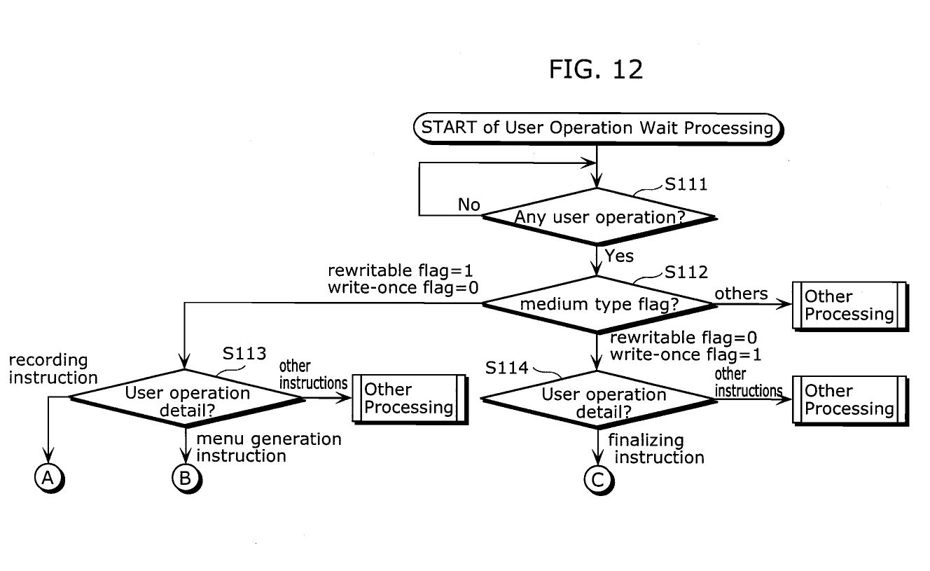

FIG. 11 is a flowchart of menu generation processing performed by the control unit 110 according to the present embodiment. FIGS. 12 to 15 show flowcharts of user operation wait processing performed by the control unit 110 according to the present embodiment. In these figures it is assumed that medium type flags each of which indicates a type of a recording medium set in the recording and reproducing device 100 are set in the control unit 110. As the medium type flags, there are a rewritable flag and a write-once flag. Then, when a rewritable recording medium is set into the recording and reproducing device 100, the rewritable flag is set to 1 and the write-once flag is set to 0. On the other hand, when a write-once recording medium is set into the recording and reproducing device 100, the rewritable flag is set to 0 and the write-once flag is set to 1. In other cases, both of the rewritable flag and the write-once flag are set to 0.

After the recording and reproducing device 100 is powered on and initialized, or after the recording medium is ejected from the recording and reproducing device 100, the menu generation processing is started as shown in FIG. 11. At this moment, values of both of the medium type flags are 0. Firstly, the control unit 110 determines whether or not a recording medium is set in the recording and reproducing device 100 (S101). If the determination is made that a recording medium is set in the recording and reproducing device 100 (Yes at S101), then it is determined whether or not the recording medium is a rewritable recording medium (S102). If the determination is made that the recording medium is a rewritable recording medium (Yes at S102), then the rewritable flag of the medium type flag is set to 1 (S103) and it is determined whether or not any menu file is recorded on the recording medium (S104). If the determination is made that no menu file is recorded on the recording medium (No at S104), then a simple form menu file is generated (S105). The generated simple form menu file is written into the recording medium (S106). After that, the menu generation processing is completed, and then the user operation wait processing of FIGS. 12 to 15 is started. Here, if the determination is made that a menu file is recorded on the recording medium (Yes at S104), then the menu generation processing is completed and the user operation wait processing of FIGS. 12 to 15 is started.

On the other hand, if the recording medium is not a rewritable recording medium (No at S102), then the control unit 110 determines whether or not the recording medium is a write-once recording medium (S107). If the determination is made that the recording medium is a write-once recording medium (Yes at S107), then the write-once flag of the medium type flag is set to 1 (S108), and then the user operation wait processing of FIGS. 12 to 15 is started. Here, if the determination is made that the set recording medium is not a write-once recording medium (No at S107), then the menu generation processing is completed and the user operation wait processing of FIGS. 12 to 15 is started.

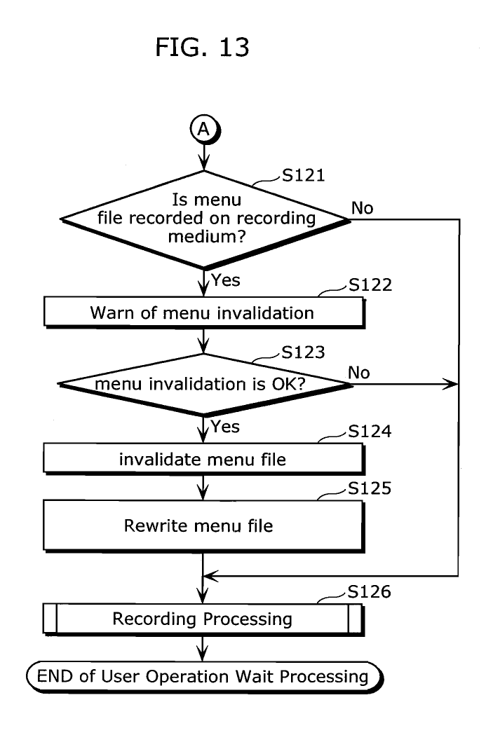

Then, as shown in FIG. 12, firstly the control unit 110 waits for an operation from a user (S111). When an operation is given from the user (Yes at S111), then values of the medium type flags are checked (S112). Here, it is assumed that as a result of the checking a value of the rewritable flag is 1 and a value of the write-once flag is 0. This means that a rewritable recording medium is set in the recording and reproducing device 100. In this case, when a recording instruction is received by a user operation (recording instruction at S113), it is firstly determined whether or not any menu file is recorded on the recording medium (S121) as shown in FIG. 13.

If the determination is made that a menu file is recorded (Yes at S121), the control unit 110 warns the user that the menu file will be invalidated, via a warning screen (S122). Then, when the user agrees with the menu invalidation in response to the warning (Yes at S123), then the menu file is invalidated (S124), a simple form menu file is generated, and the invalidated menu file is rewritten by the generated simple form menu file (S125). After that, general recording processing is performed (S126), then the user operation wait processing is completed, and next user operation wait processing is started.

Here, the recording instruction may be an operation of switching to an image capturing mode, not only operation of actually pressing a recording button. Some recording and reproducing devices having a camera function need switching between an image capturing mode of capturing images by the camera function and a reproduction mode of reproducing contents. Such recording and reproducing devices may warn their users that the switching from the reproduction mode to the image capturing mode results in a risk of invalidation of previously recorded menu files.

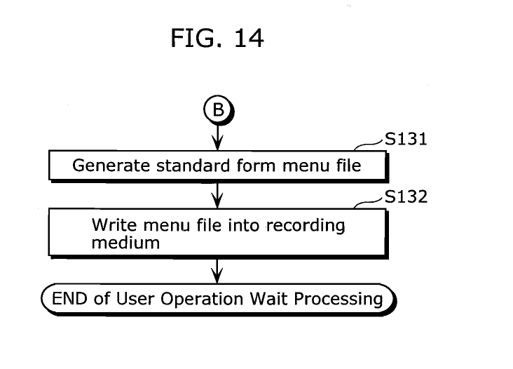

It should be note that, when a menu generation instruction is received by a user operation as shown in FIG. 12 (menu generation instruction at S113), the control unit 110 generates a standard form menu file as shown in FIG. 14 (S131), and the generated standard form menu file is written into the recording medium (S132). After that, the user operation wait processing is completed, and then next user operation wait processing is started.

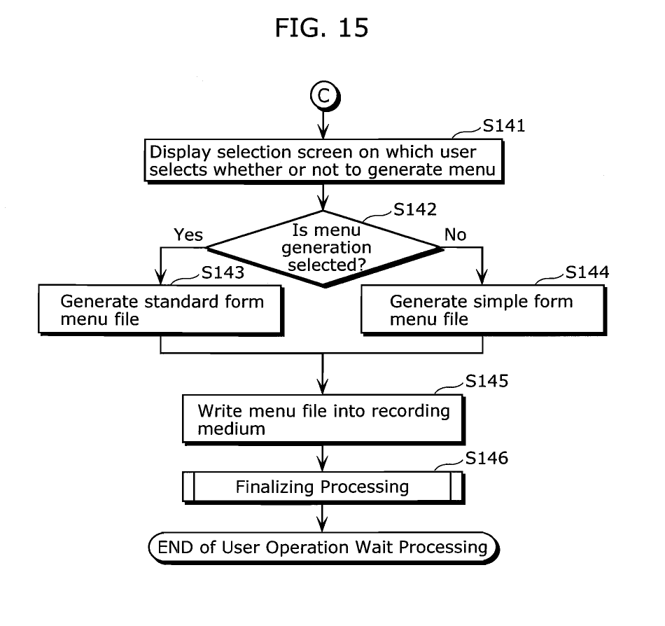

Here, as shown in FIG. 12 it is assumed that the control unit 110 determines that a value of the rewritable flag is 0 and a value of the write-once flag is 1. This means that a rewritable recording medium is set in the recording and reproducing device 100. Under the assumption, when a finalizing instruction is received by a user operation (finalizing instruction at S114), a selection screen is firstly displayed as shown in FIG. 15 to cause the user to select whether or not a menu is to be generated (S141). The selection is received from the user, and it is determined whether or not menu generation is selected (S142). If the determination is made that the menu generation is selected (Yes at S142), then a standard form menu file is generated (S143). On the other hand, if the determination is made that the menu generation is not selected (No at S142), then a simple form menu file is generated (S144). Then, the generated menu file is recorded onto the recording medium (S145), then finalizing processing is performed (S146), then the user operation wait processing is completed, and then next user operation wait processing is started.

As described above, the recording and reproducing device 100 according to the present invention can generate a simple form menu file by which contents are reproduced sequentially without displaying a menu image when a time required to generate the menu file is to be shorten. Thereby, the recording and reproducing device 100 can reduce the menu file generation processing. Furthermore, when a menu file that has been previously recorded by a recording operation is invalidated, warning about invalidation of the menu file is displayed beforehand. Thereby, undesired invalidation of a menu file can be prevented.

### Other Embodiments

It should be noted that, although the finalizing processing is not necessary in rewritable recording mediums, rewritable recording mediums may have a pseudo finalizing state to have the same operationality with write-once recording mediums. Therefore, for example, instead of the processing according to the menu file generation instruction shown in FIG. 14 (S131, S132), rewritable recording mediums performs the processing shown in FIGS. 15 (S141 to S146). Instead of actual finalizing processing after recording a menu file, rewritable recording mediums have a finalizing flag for indicating existence of finalizing processing. Thereby, the rewritable recording mediums can be in a pseudo finalizing state.

It should be noted that it has been described in the above embodiment that the simple form menu is a menu for sequentially reproducing contents. However, the simple form menu can be any menu which can eliminate coding of a background image as a “Still Picture”. Therefore, instead of sequentially reproducing the contents, it is also possible that tonly a range of a simple form menu which can be easily generated using only C&Gs is displayed, and after user's selecting, selected contents are reproduced, for example. It is also possible to generate a menu file having only C&Gs, displaying only a list of recording start times of contents to be selected.

It should also be noted that in the above embodiment the two kinds of menus that are the standard form menu and the simple form menu have been described, but kinds of menus are not limited to these menus. For example, a menu of contents recorded on the recording medium is generated in a menu form selected by a user from among various menu forms. In this case, when a menu file is to be generated and the user does not designate any specific menu form, it is also possible to automatically select a menu form in a menu file can be generated in a short time and then generate a menu file in the selected menu form. In other words, when only a standard form menu and an extended from menu that requires a longer generation time than the standard form menu are provided, the standard form menu is automatically selected.

It should also be note that it is also possible that information for specifying a menu previously set by a user is stored, and based on the information the user's previously set menu form is automatically selected, and a menu file is generated in the selected menu form.

It should also be noted that the prevent invention may include (a) a menu data recording unit operable to record menu data onto a recording medium that is portable, the menu data for displaying a menu of content data recorded on the recording medium; (b) a first form menu data generation unit operable to generate the menu data in a first menu form; (c) a second form menu data generation unit operable to generate the menu data in a second menu form that takes shorter time than the generation in the first menu form; and (d) a menu data selection unit operable to select one of said first form menu data generation unit and said second form menu data generation unit in order to generate the menu data either in the first menu form or in the second menu form.

In short, instead of generation of a simple form menu file, it is also possible to delete the standard form menu file.

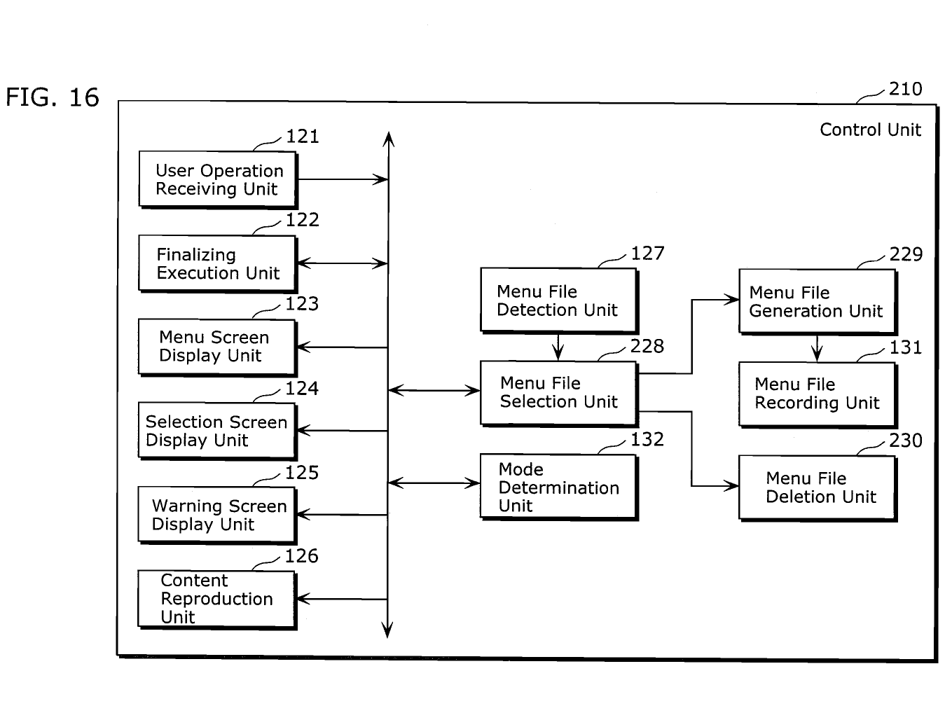

For example, the recording and reproducing device 100 may include a control unit 210 as shown in FIG. 16, instead of the control unit 110. In this structure, a menu file selection unit 228 selects a menu file generation unit 229 or a menu file deletion unit 230.

For example, the menu file selection unit 228 selects the menu file generation unit 229 to generate a menu file. Thereby, the menu file generation unit 229 generates a menu file in a standard form, and outputs the menu file in the standard form to the menu file recording unit 131. The menu file recording unit 131 records the menu file obtained from the menu file generation unit 229, onto the recording medium 10.

On the other hand, the menu file selection unit 228 selects the menu file deletion unit 230 to delete a menu file. Thereby, the menu file deletion unit 230 deletes a menu file from the recording medium 10.

That is, if every time a recording medium is set into the recording and reproducing device 100 or a recording instruction is received, existence of a menu file is checked and an appropriate processing is performed, it is also possible to delete a menu file, instead of rewiring the menu file. In this case, as described previously, even if other reproducing devices do not always perform the same reproduction processing as the recording and reproducing device 100 does, a time required to generate a menu can be eliminated.

It should also be noted that the recording and reproducing device 100 according to the present invention may include a Central Processing Unit (CPU), a system Large Scale Integration (LSI), a Random Access Memory (RAM), a Read Only Memory (ROM), a Hard Disk Drive (HDD), a network interface, and the like. Furthermore, the recording and reproducing device 100 according to the present invention may include a drive device capable of reading and wiring from/to portable recording mediums such as DVD-RAMs, Blu-ray discs, and Secure Digital (SD) memory cards.

It should also be noted that the recording and reproducing device 100 may be implemented as an embedded system such as a digital video camera, a digital recorder, a digital television set, a game machine, an IP telephone, and a portable telephone.

It should also be noted that functions of the recording and reproducing device 100 may be realized when a program (hereinafter, referred to as a “recording and reproducing program”) installed in the recording and reproducing device 100 and executed to control the recording and reproducing device 100.

It should also be noted that the recording and reproducing program may be recorded on a recording medium which a hardware system such as a computer system and an embedded system can read. Furthermore, the recording and reproducing program may be read by other hardware system via the recording medium and then executed by the other hardware system. Thereby, the functions of the recording and reproducing device 100 can be realized by other hardware systems. Here, examples of the computer-system readable recording medium are an optical recording medium such as a CD-ROM, a magnetic recording medium such as a hard disc, a magnetooptical recording medium such as a MO, a semiconductor memory such as a memory card, and the like.

Still further, the recording and reproducing program may be held in a hardware system connected to a network such as the Internet or a local area network. Still further, the recording and reproducing program may be downloaded via a network to other hardware systems and executed by the other hardware systems. Thereby, the functions of the recording and reproducing device 100 can be realized by other hardware systems. Here, examples of the network are a terrestrial broadcasting network, a satellite broadcasting network, a Power Line Communication (PLC), a mobile radio telephone network, a wire communication network such as IEEE802.3, a wireless communication network such as IEEE802.11, and the like.

It should also be noted that the functions of the recording and reproducing device 100 may be implemented as a recording and reproducing circuit embedded in the recording and reproducing device 100.

It should also be noted that the recording and reproducing circuit may be formed in a semi-custom LSI such as a full-custom LSI or an Application Specific Integrated Circuit (ASIC), a programmable logic device such as a Field Programmable Gate Array (FPGA) or a Complex Programmable Logic Device (CPLD), a dynamic reconfigurable device with a dynamically-rewritable circuit configuration, or the like.

It should also be noted that design data used for forming the functions of the recording and reproducing device 100 in a recording and reproducing circuit may be a program (hereinafter, referred to as an “HDL program”) described in a hardware description language. The design data may be a net list at a gate level obtained by logic synthesis of an HDL program. Furthermore, the design data may be macrocell information in which a net list at a gate level is added with arrangement information, a process condition, and the like. Still further, the design data maybe mask data by which a size, a timing, and the like are defined. Here, examples of the hardware description language are Very high speed integrated circuit Hardware Description Language (VHDL), Verilog-HDL, SystemC, and the like.

It should also be noted that the design data may be recoded on a recording medium that a hardware system such as an embedded system can read. Furthermore, the design data may be read by other hardware system via a recording medium and then executed by the other hardware system. Then, the design data read by the other hardware system via the recording medium may be downloaded via a download cable to a programmable logic device.

Still further, the design data may be held in a hardware system connected to a network such as the Internet or a local area network. Still further, the design data may be downloaded via a network to other hardware systems and executed by the other hardware systems. Then, the design data obtained by the other hardware system via the recording medium may be downloaded via a download cable to a programmable logic device.

It should also be noted that the design data may be recorded on a serial ROM so that the design data is transferred to a FPGA when applying current. Then, the design data recorded on the serial ROM may be downloaded directly to a FPGA when applying current.

It should also be noted that the design data may be generated by a microprocessor and downloaded to a FPGA when applying current.

### INDUSTRIAL APPLICABILITY

The present invention can be used as recording and reproducing device that records audio and video onto a portable recording medium and reproduces the recorded audio and video. Especially, the present invention can be used, for example, as a video camera that records audio and visual data to a recording medium such as a semiconductor memory and an optical disc, and records menu information used for displaying a menu screen if necessary.

1. A recording and reproducing device comprising:
a menu data recording unit operable to record menu data onto a recording medium that is portable, the menu data for displaying a menu of content data recorded on the recording medium;
a first form menu data generation unit operable to generate the menu data in a first menu form;
a second form menu data generation unit operable to generate the menu data in a second menu form that takes shorter time than the generation in the first menu form; and
a menu data selection unit operable to select one of said first form menu data generation unit and said second form menu data generation unit in order to generate the menu data either in the first menu form or in the second menu form.

2. The recording and reproducing device according to claim 1,
wherein said first form menu data generation unit is operable to generate the menu data in the first menu form including a background image; and
said second form menu data generation unit is operable to generate the menu data in the second menu form, so that the menu data does not have any background image.

3. The recording and reproducing device according to claim 1, further comprising
a menu data detection unit operable to detect whether or not the menu data is recorded on the recording medium, when the recording medium is set into said recording and reproducing device,
wherein said menu data selection unit is operable to select said second form menu data generation unit to generate the menu data in the second menu form, when said menu data detection unit detects that the menu data is not recorded on the recording medium.

4. The recording and reproducing device according to claim 1,
wherein said menu data selection unit is operable to select said second form menu data generation unit to generate the menu data in the second menu form, when content data registered in the menu data is different from the content data recorded on the recording medium in ejecting the recording medium from said recording and reproducing device.

5. The recording and reproducing device according to claim 1,
wherein said menu data selection unit is operable to select said second form menu data generation unit to generate the menu data in the second menu form, when recording of new content data is started or completed.

6. The recording and reproducing device according to claim 5, further comprising
a warning screen display unit operable to display a warning screen to warn of invalidation of the menu, if the menu data is recorded on the recording medium when said recording and reproducing device is switched to a state of recording the new content data or when said recording and reproducing device starts the recording of the new content data.

7. The recording and reproducing device according to claim 6
wherein said recording and reproducing device is a video camera, and
the state of recording the new content data is a mode of capturing image by said video camera.

8. The recording and reproducing device according to claim 1, further comprising
a user operation receiving unit operable to receive, from a user, an intention whether or not to generate the menu,
wherein said menu data selection unit is operable to select said first form menu data generation unit to generate the menu data in the first menu form, when said user operation receiving unit receives an intention to generate the menu.

9. The recording and reproducing device according to claim 8, further comprising
a selection screen display unit operable to display a selection screen on which the user selects whether or not the menu is to be generated, when finalizing processing is to be performed in the recording medium,
wherein said user operation receiving unit is operable to receive, from the user, the intention whether or not to generate the menu, via the selection screen, and
said menu data selection unit is operable to select said second form menu data generation unit to generate the menu data in the second menu form, when said user operation receiving unit receives an intention not to generate the menu.

10. A recording and reproducing device comprising:
a menu data recording unit operable to record menu data onto a recording medium, the menu data being included in a menu of content data recorded on the recording medium that is portable;
a menu data generation unit operable to generate the menu data that is to be recorded on the recording medium;
a menu data deletion unit operable to delete the menu data that is recorded on the recording medium; and
a menu data selection unit operable to select one of said menu data generation unit and said menu data deletion unit in order to select whether the menu data is to be generated or deleted.

11. The recording and reproducing device according to claim 10,
wherein said menu data selection unit is operable to select said menu data deletion unit to delete the menu data, when content data registered in the menu data is different from the content data recorded on the recording medium in ejecting the recording medium from said recording and reproducing device.

12. The recording and reproducing device according to claim 10,
wherein said menu data selection unit is operable to select said menu data deletion unit to delete the menu data, when recording of new content data is started or completed.

13. The recording and reproducing device according to claim 12, further comprising
a warning screen display unit operable to display a warning screen to warn of invalidation of the menu, if the menu data is recorded on the recording medium when said recording and reproducing device is switched to a state of recording the new content data or when said recording and reproducing device starts the recording of the new content data.

14. The recording and reproducing device according to claim 13
wherein said recording and reproducing device is a video camera, and
the state of recording the new content data is a mode of capturing image by said video camera.

15. The recording and reproducing device according to claim 10, further comprising
a user operation receiving unit operable to receive, from a user, an intention whether or not to generate the menu,
wherein said menu data selection unit is operable to select said menu data generation unit to generate the menu data, when said user operation receiving unit receives an intention to generate the menu.

16. The recording and reproducing device according to claim 15, further comprising
a selection screen display unit operable to display a selection screen on which the user selects whether or not the menu is to be generated, when finalizing processing is to be performed in the recording medium,
wherein said user operation receiving unit is operable to receive, from the user, the intention whether or not to generate the menu, via the selection screen, and
said menu data selection unit is operable to select said menu data deletion unit to delete the menu data, when said user operation receiving unit receives an intention not to generate the menu.

17. A recording and reproducing method comprising:
a menu data recording step of recording menu data onto a recording medium, the menu data being included in a menu of content data recorded on the recording medium that is portable;
a first form menu data generation step of generating the menu data in a first menu form;
a second form menu data generation step of generating the menu data in a second menu form that takes shorter time than the generation in the first menu form; and
a menu data selection step of selecting one of said first form menu data generation step and said second form menu data generation step in order to generate the menu data either in the first menu form or in the second menu form.

18. A recording and reproducing program causing a computer to execute:
a menu data recording step of recording menu data onto a recording medium, the menu data being included in a menu of content data recorded on the recording medium that is portable;
a first form menu data generation step of generating the menu data in a first menu form;
a second form menu data generation step of generating the menu data in a second menu form that takes shorter time than the generation in the first menu form; and
a menu data selection step of selecting one of said first form menu data generation step and said second form menu data generation step in order to generate the menu data either in the first menu form or in the second menu form.

19. An integrated circuit comprising:
a menu data recording unit operable to record menu data onto a recording medium, the menu data being included in a menu of content data recorded on the recording medium that is portable;
a first form menu data generation unit operable to generate the menu data in a first menu form;
a second form menu data generation unit operable to generate the menu data in a second menu form that takes shorter time than the generation in the first menu form; and
a menu data selection unit operable to select one of said first form menu data generation unit and said second form menu data generation unit in order to generate the menu data either in the first menu form or in the second menu form.
